(19) United States
(12) Patent Application Publication
(10) Pub. No.: US 2012/0271500 A1
(43) Pub. Date: Oct. 25, 2012

(54) SYSTEM AND METHOD FOR ENABLING A DRIVER TO INPUT A VEHICLE CONTROL INSTRUCTION INTO AN AUTONOMOUS VEHICLE CONTROLLER

(75) Inventors: Omer TSIMHONI, Herzliya (IL); Claudia V. GOLDMAN-SHENHAR, Mevasseret Zion (IL)

(73) Assignee: GM GLOBAL TECHNOLOGY OPERATIONS LLC, DETROIT, MI (US)

(21) Appl. No.: 13/090,922

(22) Filed: Apr. 20, 2011

(51) Int. Cl. G05D 1/02

(52) U.S. Cl. 701/23

(57) ABSTRACT

A system for enabling a driver to input a vehicle control instruction into an autonomous vehicle controller while the autonomous vehicle controller is operating a vehicle in either an autonomous mode or a semi-autonomous mode is disclosed herein. The system includes, but is not limited to, a sensor that is configured to detect a driver input and to generate a signal corresponding with the driver input. The system further includes a communication sub-system communicatively coupled with the sensor and configured to be communicatively coupled with the autonomous vehicle controller. The communication sub-system is further configured to deliver the signal from the sensor to the autonomous vehicle controller. The autonomous vehicle controller controls the vehicle in a manner that corresponds with the driver input when the autonomous vehicle controller receives the signal.

### TECHNICAL FIELD

The technical field generally relates to vehicles, and more particularly relates to a system and method for enabling a driver to input a vehicle control instruction into an autonomous vehicle controller.

### BACKGROUND

An autonomous vehicle control system uses a controller (an “autonomous vehicle controller”) and a variety of sensors and/or other vehicle systems to control a vehicle as it is operating. Autonomous vehicle control systems may be either semi-autonomous (i.e., requiring a driver's supervisory presence) or fully autonomous (i.e., requiring no involvement by a driver) and will respectively enable a driver of a vehicle to either reduce, or eliminate altogether, the attention that the driver would otherwise have to give to the task of driving the vehicle.

In order to provide a vehicle control input while the autonomous vehicle control system is engaged, the driver must first disengage the system. Once the system has been disengaged, the driver may then input a desired course, heading, speed, or other correction. Once the correction has been made, the driver may then re-engage the system.

While this solution is adequate, there is room for improvement. There may be occasions when the driver wishes to provide a vehicle control input that affects the control of the vehicle without disengaging the autonomous vehicle control system. For instance, the autonomous vehicle controller may be configured to steer the vehicle down the center of a traffic lane while the driver's preference may be to position the vehicle closer to the left or right side of the traffic lane. Furthermore, the autonomous vehicle controller may be configured to travel at a constant speed while the driver may wish to alter the vehicle's speed based on environmental conditions. It is desirable to provide a way for a driver to communicate a vehicle control input to the autonomous vehicle controller without disengaging the autonomous vehicle control system.

### SUMMARY

A system and method for enabling a driver to input a vehicle control instruction into an autonomous vehicle controller while the autonomous vehicle controller is operating a vehicle in either an autonomous mode or a semi-autonomous mode is disclosed herein.

In a first, non-limiting embodiment, the system includes, but is not limited to, a sensor that is configured to detect a driver input and to generate a signal corresponding with the driver input. The system further includes a communication sub-system that is communicatively coupled with the sensor and configured to be communicatively coupled with the autonomous vehicle controller. The communication sub-system is further configured to deliver the signal from the sensor to the autonomous vehicle controller. The autonomous vehicle controller controls the vehicle in a manner corresponding with the driver input when the autonomous vehicle controller receives the signal.

In another, non-limiting embodiment, the system includes, but is not limited to, a first sensor that is configured to detect a driver input and to generate a first signal corresponding with the driver input. The system further includes a processor that is communicatively coupled with the first sensor and that is adapted to be operatively coupled with the autonomous vehicle controller. The processor is configured to obtain the first signal from the first sensor and in response to the first signal, (i) to determine a driver intent based, at least in part, on the first signal, and (ii) to provide the autonomous vehicle controller with a command corresponding with the driver intent. As a result, the autonomous vehicle controller controls the vehicle in a manner that corresponds with the command when the autonomous vehicle controller receives the command.

In another, non-limiting embodiment, the method includes detecting a driver input with a sensor. The method further includes generating, with the sensor, a signal corresponding with the driver input. The method further includes determining, with a processor, a driver intent based, at least in part, on the signal. The method further includes generating, with a processor, a command that corresponds with the driver intent. The method further includes providing the command to the autonomous vehicle controller. The method still further includes controlling the vehicle with the autonomous vehicle controller in a manner that corresponds with the command.

### DESCRIPTION OF THE DRAWINGS

One or more embodiments will hereinafter be described in conjunction with the following drawing figures, wherein like numerals denote like elements, and

FIG. 1 is a schematic view illustrating a non-limiting embodiment of a system for enabling a driver to input a vehicle control instruction into an autonomous vehicle controller while the autonomous vehicle controller is operating a vehicle in either an autonomous mode or a semi-autonomous mode;

FIG. 2 is a schematic view illustrating another non-limiting embodiment of a system for enabling a driver to input a vehicle control instruction into an autonomous vehicle controller while the autonomous vehicle controller is operating a vehicle in either an autonomous mode or a semi-autonomous mode wherein a processor is operatively coupled with the autonomous vehicle controller, the sensor and an electronic data storage unit;

FIGS. 3-4 illustrate the use of the systems of FIGS. 1 and 2 to provide a vehicle control input into an autonomous vehicle controller to control a vehicle;

FIGS. 5-6 illustrate the use of the systems of FIGS. 1 and 2 to provide another vehicle control input into an autonomous vehicle controller to control a vehicle;

FIGS. 7-8 illustrate the use of the systems of FIGS. 1 and 2 to provide still another vehicle control input into an autonomous vehicle controller to control a vehicle;

FIG. 9 is a block diagram illustrating a method for enabling a driver to input a vehicle control instruction into an autonomous vehicle controller while the autonomous vehicle controller is operating a vehicle in either an autonomous mode or a semi-autonomous mode.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

A system and method for enabling a driver to input a vehicle control instruction into an autonomous vehicle controller while the autonomous vehicle controller is operating a vehicle in either an autonomous mode or a semi-autonomous mode is disclosed herein. In one embodiment, the system includes a sensor that is configured to detect driver inputs and a communication sub-system that is configured to convey inputs detected by the sensor to the autonomous vehicle controller.

The sensor is located within a vehicle and is accessible to an occupant of the vehicle. In some embodiments, the sensor may comprise a touch sensitive surface that is configured to detect touches made by a touching member (e.g., a finger, multiple fingers, the palm of hand, a stylus, etc. . . . ) that physically contacts the touch sensitive surface. Multiple technologies exist for detecting a user's touch using a touch sensitive surface including those disclosed in U.S. Pat. Nos. 4,521,870; 4,821,031; 5,038,142; 5,956,021; 6,259,491; 6,297,811; and 6,492,979, the disclosures of which are hereby incorporated herein in their entirety by reference. In some embodiments the touch sensitive surface may be mounted to a steering wheel (e.g., to a hub or rim) while in other embodiments, the touch sensitive surface may be mounted to, or integrated into, any suitable surface within the passenger compartment of the vehicle. The touch sensitive surface is configured to detect gestures that are imparted on the touch sensitive surface and is further configured to generate a signal that corresponds with such touch and/or gesture.

The communication sub-system may be any system or device that is configured to communicate the signal from the sensor to the autonomous vehicle controller. For example, the communication sub-system may comprise a mechanical connection, including, but not limited to a lead, a wire, and/or a coaxial cable that communicatively connects the sensor to the autonomous vehicle controller. In other embodiments, the communication sub-system may comprise a wireless transmitter that is configured for short range communication including, but not limited to, a WiFi transmitter and/or a Bluetooth transmitter.

Using the system described above, the driver may make a gesture on the touch sensitive surface that corresponds with a desired vehicle control input (i.e., an input that will result in an increase or decrease in the vehicle speed, a leftward or rightward adjustment within a traffic lane, a lane change, or any other change in the vehicle's position and/or dynamic condition) using a touching member. The touch sensitive surface will generate a signal that corresponds with the gesture and that signal is then communicated to the autonomous vehicle controller by the communication sub-system. The autonomous vehicle controller is configured to receive the signal, to interpret the signal, and in response to the signal, to alter the speed, course, or other dynamic condition of the vehicle in a manner that corresponds with the signal. For example, if the driver swipes a finger across the touch sensitive surface in a leftward direction, the autonomous vehicle controller will make a leftward adjustment of the position of the vehicle within a traffic lane.

A further understanding of the above described system and method may be obtained through a review of the illustrations accompanying this application together with a review of the detailed description that follows.

FIG. 1 is a schematic view illustrating a non-limiting embodiment 20 of a system for enabling a driver to input a vehicle control instruction into an autonomous vehicle controller 22 while autonomous vehicle controller 22 is operating a vehicle 24 in either an autonomous mode or a semi-autonomous mode. Embodiment 20 includes a sensor 26 and a communication sub-system 28. Sensor 26 may comprise any type of sensor that is configured to detect a driver input 30 by a driver or other occupant of vehicle 24 (referred to herein as a “driver input”). In one non-limiting embodiment, sensor 26 may comprise a touch sensitive surface that is configured to detect a touch and/or a gesture made by a touching member as it contacts and/or it moves across the touch sensitive surface. In other non-limiting embodiments, sensor 26 may comprise a motion sensor, a voice recognition system, a trackball, a mouse, keyboard, a joystick, a camera or any other type of device that is configured to receive and/or detect driver inputs and that is further configured to generate a signal 32 corresponding with driver input 30 when driver input 30 is received/detected.

As set forth above, communication sub-system 28 may comprise any type of sub-system and/or device that is configured to transmit, deliver, provide, or otherwise convey signal 32 including, but not limited to, the above described wired and wireless communicative coupling devices. In the example illustrated in FIG. 1, communication sub-system 28 comprises a wireless transmitter. As illustrated, autonomous vehicle controller 22 is configured to receive wireless transmissions from communication sub-system 28. A wireless arrangement such as the arrangement depicted in FIG. 1 may be employed in circumstances where it is not convenient to establish a wired connection between sensor 26 and autonomous vehicle controller 22.

Sensor 26 is configured to receive driver input 30 and to generate a signal 32 that corresponds with driver input 30. For example, in an embodiment where sensor 26 comprises a touch sensitive surface mounted within the passenger compartment of vehicle 24, sensor 26 would be configured to generate a signal indicative of a pattern traced across the touch sensitive surface by the driver. Communication sub-system 28 is configured to wirelessly transmit signal 32 to autonomous vehicle controller 22. Upon receipt of signal 32, autonomous vehicle controller 22 is configured to interpret signal 32 to determine the driver's intent and to send an instruction 36 to a vehicle control system 38 to carry out the driver's intent. For example, if the gesture that is input by the driver corresponds with a driver's intent to reposition vehicle 24 within its traffic lane, autonomous vehicle controller 22 would send instruction 36 to a controller to reposition the vehicle within the traffic lane based on its internal control mechanism. The controller will cause the wheels of the vehicle 24 to briefly turn left and then return to a straightforward position, then turn right and return to straightforward again.

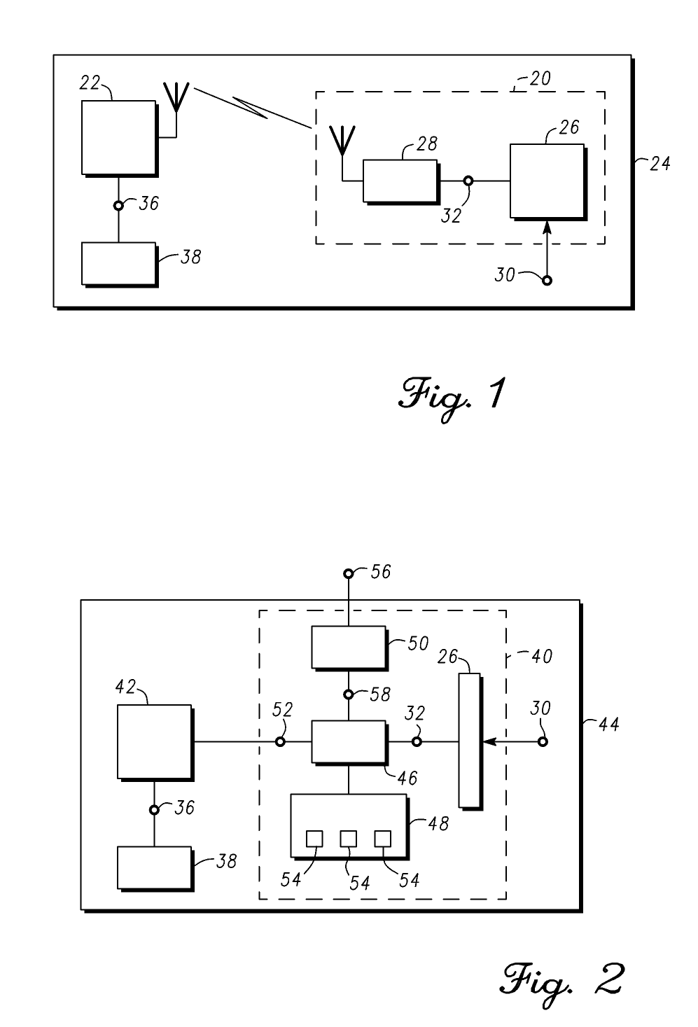

FIG. 2 is a schematic view illustrating another non-limiting embodiment 40 of a system for enabling a driver to input a vehicle control instruction into an autonomous vehicle controller 42 while autonomous vehicle controller 42 is operating a vehicle 44 in either an autonomous mode or a semi-autonomous mode. Embodiment 40 includes sensor 26 to receive driver input 30. Embodiment 40 further includes a processor 46 which is operatively coupled with autonomous vehicle controller 42, an electronic data storage 48, and a sensor 50.

Processor 46 may be any type of computer, computer system, or microprocessor that is configured to perform algorithms, to execute software applications, to execute sub-routines and/or to be loaded with and to execute any other type of computer program. In some embodiments, processor 46 may comprise only a single component. In other embodiments, processor 46 may comprise a plurality of components acting in concert. In some embodiments, processor 46 may be dedicated for use exclusively with embodiment 40 while in other embodiments, processor 46 may be shared with other systems on board vehicle 44.

Processor 46 is communicatively coupled with sensor 26. In the illustrated embodiment, processor 46 is directly connected to sensor 26. In other embodiments, these components may be communicatively connected to one another across a vehicle bus. In still other embodiments, processor 46 and sensor 26 may be wirelessly communicatively coupled with one another via a Bluetooth connection, a WiFi connection, an infrared connection, or the like.

When sensor 26 detects driver input 30, sensor 26 is configured to generate signal 32 and to transmit signal 32 to processor 46. Signal 32 contains information that is indicative of driver input 30. Processor 46 is configured to receive signal 32 and, in response to signal 32, to determine the driver's intent. For example, in an embodiment where sensor 26 comprises a touch sensitive surface mounted to the rim of a steering wheel, a driver may provide an input wherein the driver wraps his or her hand around the steering wheel and twists his or her hand in a forward direction. Signal 32 will include information indicative of the gesture detected by sensor 26. In this example, processor 46 may be configured to interpret a forward twisting motion about the rim of the steering wheel as an expression by the driver of his or her intent to increase the speed a vehicle 44. In some embodiments, processor 46 may be programmed to interpret one or more gestures as corresponding with one or more driver intents. In other embodiments, processor 46 may be configured to retrieve information stored in electronic data storage unit 48 when interpreting signal 32 to determine driver intent.

Once the driver intent has been determined by processor 46, processor 46 is configured to generate a command 52 that corresponds with the driver's intent. Processor 46 is still further configured to transmit command 52 to autonomous vehicle controller 42 for further action. When autonomous vehicle controller 42 receives command 52, autonomous vehicle controller is configured to generate and transmit instruction 36 to vehicle control system 38. In the present example, where the driver's intent is to increase the speed a vehicle 44, instruction 36 will be directed to a longitudinal controller of vehicle 44 that will adjust the speed of the vehicle based on its internal control mechanism by causing the throttle controller to open and close so as to increase the speed of vehicle 44.

To reduce the possibility of a driver unintentionally inputting a vehicle control input into autonomous vehicle controller 42, processor 46 may be further configured to refrain from responding to signal 32 unless signal 32 contains information indicating that driver input 30 was intentional. For instance, in examples where sensor 26 comprises a touch sensitive surface, the driver may be required to touch the touch sensitive surface at a specific location prior to inputting a gesture. In other embodiments, the driver may be required to tap the touch sensitive surface within a predetermined period of time prior to inputting the gesture. In still other embodiments, the driver may be required to use two hands to contact the touch sensitive surface at two distinct locations when inputting the driver input. In still other embodiments, any precaution that is effective to convey to processor 46 that the driver input was intentional may be employed.

As set forth above, embodiment 44 includes an electronic data storage unit 48. Electronic data storage unit 48 may be any type of electronic memory device that is configured to store data, including, but not limited to, non-volatile memory, disk drives, tape drives, and mass storage devices and may include any suitable software, algorithms and/or sub-routines that provide the data storage component with the capability to store, organize, and permit retrieval of data. Electronic data storage unit 48 is operatively coupled with processor 46 and is configured to respond to inquiries and commands provided by processor 46.

In an embodiment, electronic data storage unit 48 is configured to store a plurality of data files 54, each of which may include information relating to historical driver inputs that have been input into sensor 26 by a corresponding plurality of drivers. In such embodiments, processor 46 may be configured to forward information corresponding to signal 32 and/or information corresponding to command 52 to electronic data storage unit 48 for storage in one or more of data files 54 each time that driver input 30 is detected by sensor 26. Processor 46 may be configured to run algorithms that characterize the user input in such a way that can be saved and retrieved from the memory unit. In other embodiments, sensor 26 may be communicatively connected to electronic data storage unit 48 and may be configured to forward signal 32 directly to electronic data storage unit 48. Processor 46 may be configured to interrogate electronic data storage unit 48 each time that processor 46 receives signal 32 from sensor 26 and to ascertain historical driver inputs that were previously input by a particular driver. Processor 46 may be further configured to utilize the information contained in the plurality of data files 54, together with signal 32, to ascertain a driver's intent. Awareness of a particular driver's previous inputs may be helpful in interpreting the intent of that driver when the driver provides future driver inputs. In this way, embodiment 40 can be personalized for different drivers of vehicle 44.

Sensor 50 is communicatively coupled with processor 46 and may be configured to detect an environmental circumstance 56. Sensor 50 is configured to generate a signal 58 that contains information corresponding with environmental circumstance 56 and is further configured to provide signal 58 to processor 46. Processor 46 is further configured to utilize the information contained in signal 58 when interpreting driver intent. For example, sensor 50 may comprise a proximity sensor that is configured to detect the proximity of other vehicles sharing the road with a vehicle 44. When processor 46 receives signal 58 indicating that vehicle 44 is drawing near a vehicle in an adjacent lane, processor 46 may use this information to interpret signal 32. Processor 46 may utilize both the information provided in signal 58 and in signal 32 to determine that the driver intent is to reposition vehicle 44 away from the approaching vehicle in the adjacent lane while remaining within the traffic lane to provide a wide berth as one of vehicle overtakes the other. In still other embodiments, processor 46 may be configured to instruct electronic data storage unit 48 to store the information contained in signal 58 in a data file 54 corresponding with the current driver a vehicle 44. This allows further personalization of embodiment 44 by collecting and utilizing information relating to a particular driver's preferences when faced with particular environmental circumstances.

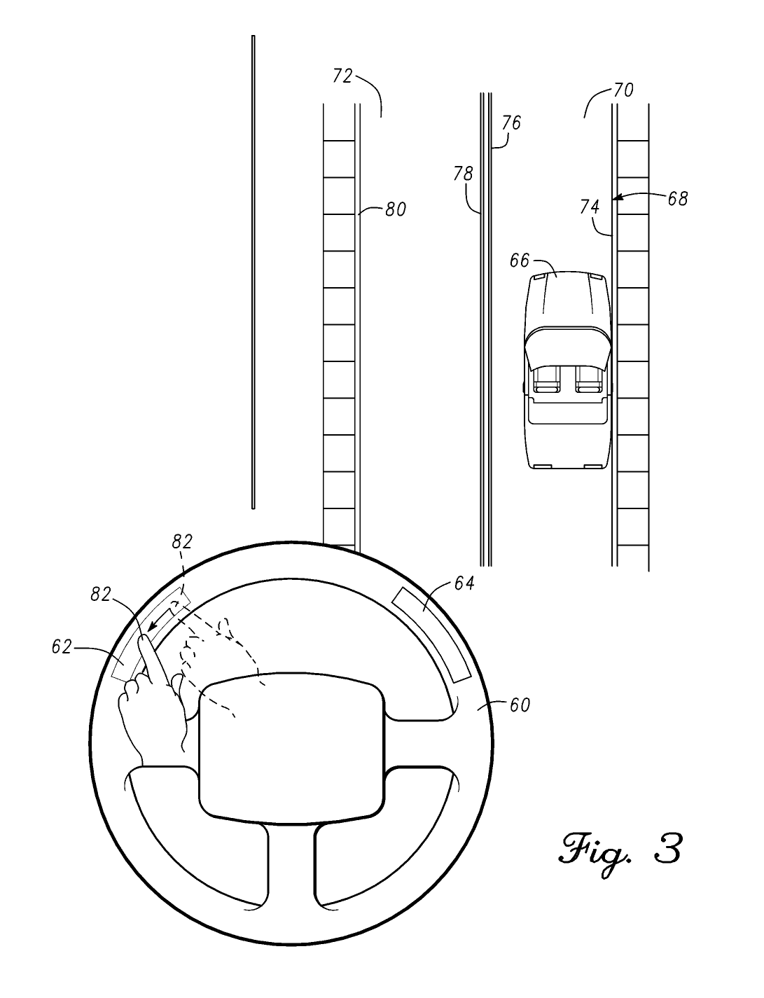

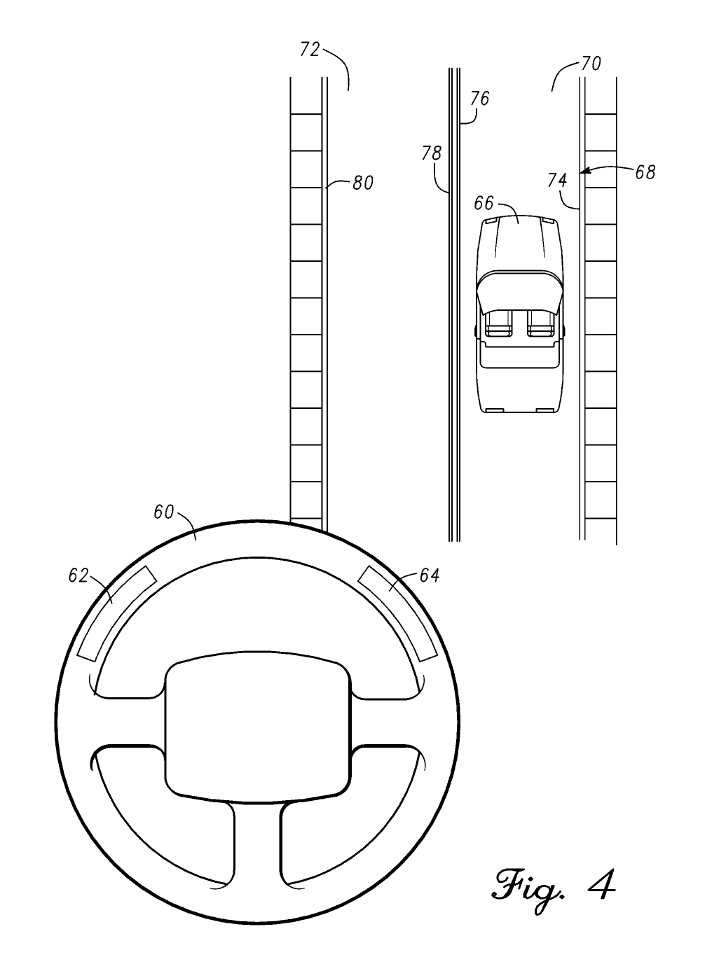

FIGS. 3-4 illustrate the effect of using a system such as embodiment 20 of FIG. 1 and/or embodiment 40 of FIG. 2 to input a vehicle control instruction into autonomous vehicle controller. With continuing reference to FIGS. 1-4, FIG. 3 illustrates a steering wheel 60 configured for use with embodiments 20 and 40. Steering wheel 60 includes touch sensitive surfaces 62 and 64. Touch sensitive surfaces 62 and 64 are each configured to detect a touch and/or gesture made by touching member contacting or sliding across their respective surfaces. Touch sensitive surfaces 62 and 64 are further configured to generate a signal corresponding with the detected touch and/or gesture and to provide that signal to either a communication sub-system for transmission to autonomous vehicle controller or for transmission to a processor for processing prior to transmission to an autonomous vehicle controller. In the illustrated embodiment, two discrete touch sensitive surfaces have been illustrated. In other embodiments, a larger or smaller number of discrete touch sensitive surfaces may be utilized. In still other embodiments, steering wheel 60 may be completely or substantially completely encased in a touch sensitive surface such that the entire steering wheel is configured to receive a driver input.

Also illustrated in FIG. 3 is a vehicle 66 equipped with both an autonomous vehicle controller and an embodiment of a system for enabling a driver to input a vehicle control instruction into the autonomous vehicle controller while the autonomous vehicle controller is operating a vehicle in either an autonomous mode or a semi-autonomous mode. In FIGS. 3 and 4, it should be understood that vehicle 66 is being operated by the autonomous vehicle controller and further that steering wheel 60 is mounted within vehicle 66.

Vehicle 66 is situated on a road surface 68, which is a conventional two-lane highway, having a lane 70 for traffic traveling in one direction and a lane 72 for traffic traveling in an opposite direction. A lane marker 74 and a lane marker 76 delineate the boundaries of lane 70 and a lane marker 78 and a lane marker 80 delineate the boundaries of lane 72. FIG. 3 depicts a situation where the autonomous vehicle controller has positioned vehicle 66 in close proximity to lane marker 74. In some embodiments, a driver of vehicle 66 wishing to move vehicle 66 in a direction away from lane marker 74 need only position their finger 82 at an upper right hand portion of touch sensitive surface 62 (as indicated in phantom lines) and then slide finger 82 in a leftward and downward direction along a partial length of touch sensitive surface 62. This movement is a fairly intuitive because it mimics the motion of turning the steering wheel in the direction of desired vehicle movement. As illustrated in FIG. 4, this gesture is interpreted by processor 46 of embodiment 40 or autonomous vehicle controller 22 of embodiment 20 as an intent of the driver to move vehicle 66 in a leftward direction and consequently, autonomous vehicle controller 22 and/or autonomous vehicle controller 42 will exercise control over vehicle 66 in order to reposition vehicle 66 accordingly. In other embodiments, a leftward sweep of finger 82 on either touch sensitive surface 62 or touch sensitive surface 64 may achieve the same result. In still other embodiments, any other suitable gesture may be employed to move vehicle 66 in any desired direction.

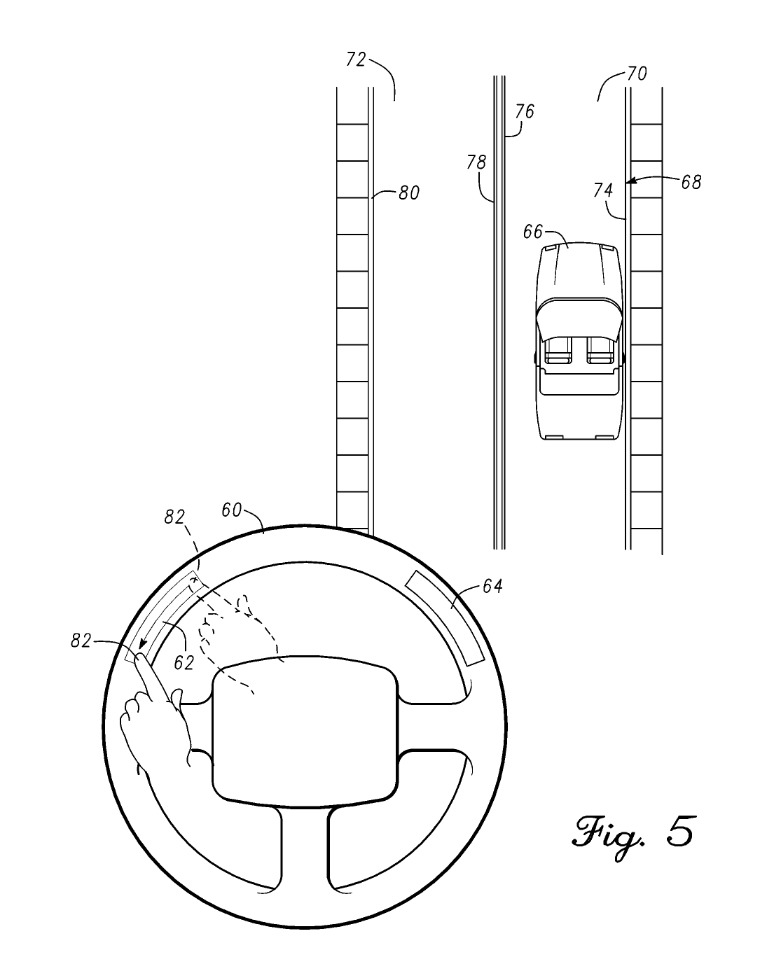

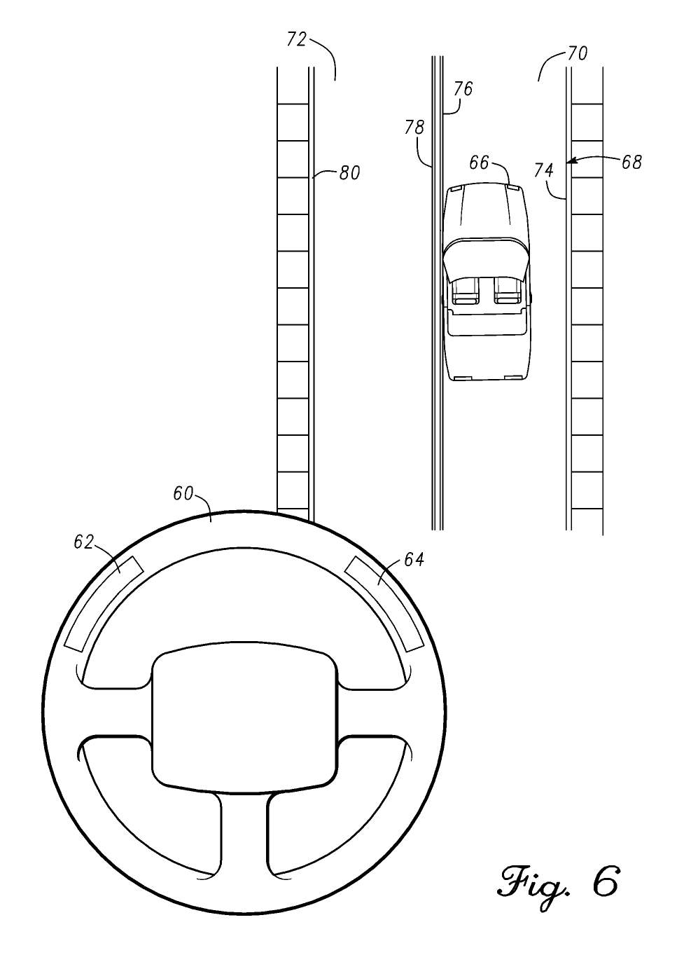

FIGS. 5-6 illustrate a situation similar to the situation depicted in FIGS. 3-4 where vehicle 66 is in close proximity to lane marker 74 and where the driver wishes to move vehicle 66 away from lane marker 74. The embodiment of the system for enabling a driver to input a vehicle control instruction into an autonomous vehicle controller that is mounted to vehicle 66 of FIGS. 3-6 is configured such that the magnitude of the vehicle control exercised by the autonomous vehicle controller on vehicle 66 will correspond with the magnitude of the driver input provided by the driver on touch sensitive surfaces 62 and 64. Autonomous vehicle controller 22, associated with embodiment 20, and processor 46, of embodiment 40, may each be configured to not only determine the driver intent based on the driver input but to also determine the magnitude of the vehicle control input intended by the driver based on the magnitude of the driver input provided by the driver.

In FIGS. 5-6, the driver wishes to reposition vehicle 66 a greater distance away from lane marker 74 than the repositioning that occurred in FIG. 4. Accordingly, as illustrated in FIG. 5, the driver positions finger 82 proximate an upper right hand portion of touch sensitive surface 62 and then slides finger 82 in a leftward and downward direction along substantially an entire length of touch sensitive surface 62. The magnitude of this driver input exceeds the magnitude of the driver input illustrated in FIG. 3. As illustrated in FIG. 6, when the driver slides finger 82 along substantially an entire length of touch sensitive surface 62, vehicle 66 moves a greater distance in the leftward direction as compared with the movement of vehicle 66 depicted in FIG. 4. In this manner, the driver can control the magnitude of the vehicle control exerted by the autonomous vehicle controller. The correlation between the magnitude of driver input and the magnitude of the corresponding vehicle control exercised by the autonomous vehicle controller may apply to any gestures that the system is configured to recognize.

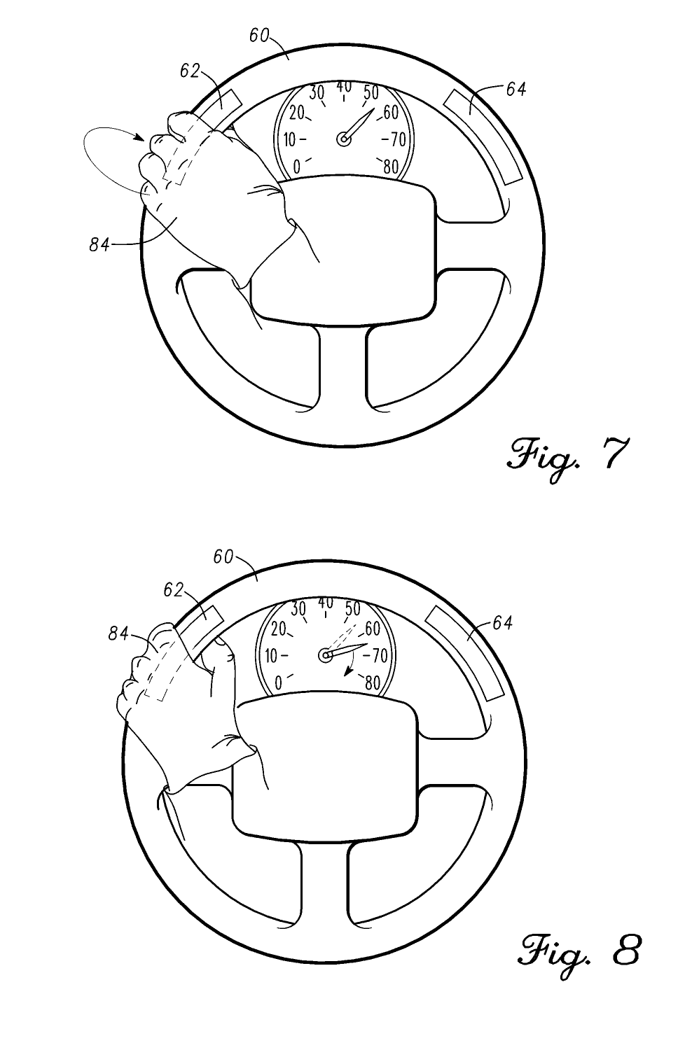

FIGS. 7-8 illustrate another gesture that a driver may use to exercise control over a vehicle being controlled by an autonomous vehicle controller without disengaging the autonomous vehicle controller. With continuing reference to FIGS. 1-8, in FIG. 7, the vehicle is traveling at approximately 55 mph and the driver wishes to increase the speed of the vehicle. To do so, the driver positions hand 84 over touch sensitive surface 62 and twists hand 84 in a forward direction. This gesture will be interpreted by either the autonomous vehicle controller 22 of FIG. 1 or processor 46 of FIG. 2 as an intent by the driver to increase the speed of the vehicle. As illustrated in FIG. 8, the vehicle's speed has been increased from approximately 55 mph to approximately 65 mph. To decrease the speed of the vehicle, the driver may place hand 84 over touch sensitive surface 62 and twists hand 84 in the direction opposite to that depicted in FIG. 7. In some embodiments, the magnitude of the twisting motion may impact the magnitude of the speed increase or decrease.

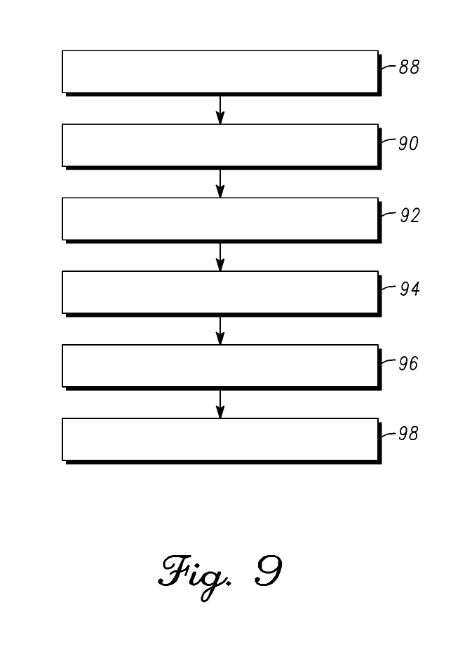

FIG. 9 is a block diagram illustrating a method 86 for enabling a driver to input a vehicle control instruction into an autonomous vehicle controller while the autonomous vehicle controller is operating a vehicle in either an autonomous mode or a semi-autonomous mode. At block 88, a driver input is detected. The driver input may comprise any suitable action on the part of the driver including, but not limited to, the movement of a touching member across a touch sensitive surface, the movement of a body part within the range of a motion detector, and the use of the driver's voice to issue verbal commands to a voice recognition system. In still other embodiments of method 86, a driver may take any other action that is conventionally utilized by a person when interacting with a human machine interface.

At block 90, a signal is generated that corresponds with the driver input. In an example where the driver's input comprises movement of a touching member across a touch sensitive surface, the signal will correspond with the pattern of touch detected by the touch sensitive surface.

At block 92, a processor is utilized to determine the driver's intent based on the information provided by the signal. In some embodiments, the processor may be programmed to recognize a predetermined number of gestures. In other embodiments, an electronic data storage unit may store information pertaining to a variety of possible gestures and a corresponding interpretation of driver intent. The processor may be configured to interact with the electronic data storage unit to determine driver intent each time a signal is received. The processor may be further configured to determine whether the input that was provided by the driver was intentional. Such a determination may be made in many different ways. For example, in a system that utilizes a touch sensitive surface, a specific initiating touch or gesture may be required prior to the inputting of the driver input to alert the system at the input was intentional. In a system that uses voice recognition software to receive driver inputs, a specific word or phrase may be required prior to the inputting of a command before the system will recognize the driver input as being intentional.

At block 94, the processor is configured to generate a command that corresponds with driver intent. The command will contain information that is compatible with, and that is interpretable by, the autonomous vehicle controller.

At block 96, the command is provided to the autonomous vehicle controller by the processor. The command may be communicated via any suitable communication means including both a wired and wireless coupling.

At block 98, the autonomous vehicle controller controls the vehicle in a manner that corresponds with the command received from the processor. In some examples, the control exerted by the autonomous vehicle controller will correspond with the magnitude of the driver input.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A system for enabling a driver to input a vehicle control instruction into an autonomous vehicle controller while the autonomous vehicle controller is operating a vehicle in either an autonomous mode or a semi-autonomous mode, the system comprising:
a sensor configured to detect a driver input and to generate a signal corresponding with the driver input; and
a communication sub-system communicatively coupled with the sensor and configured to be communicatively coupled with the autonomous vehicle controller, the communication sub-system being further configured to deliver the signal from the sensor to the autonomous vehicle controller,
wherein the autonomous vehicle controller controls the vehicle in a manner corresponding with the driver input when the autonomous vehicle controller receives the signal.

2. The system of claim 1, wherein the sensor comprises a touch sensitive surface configured to detect a gesture.

3. The system of claim 2, wherein the touch sensitive surface is mounted on a rim of a steering wheel of the vehicle.

4. The system of claim 2, wherein the gesture comprises movement of a touching member along the touch sensitive surface in a direction corresponding with a desired direction of lateral movement of the vehicle within a traffic lane.

5. The system of claim 2, wherein the gesture comprises movement of a touching member along the touch sensitive surface in a direction corresponding with a desired acceleration of the vehicle.

6. A system for enabling a driver to input a vehicle control instruction into an autonomous vehicle controller while the autonomous vehicle controller is operating a vehicle in either an autonomous mode or a semi-autonomous mode, the system comprising:
a first sensor configured to detect a driver input and to generate a first signal corresponding with the driver input;
a processor communicatively coupled with the first sensor and adapted to be operatively coupled with the autonomous vehicle controller, the processor configured to obtain the first signal from the first sensor and in response to the first signal, (i) to determine a driver intent based, at least in part, on the first signal, and (ii) to provide the autonomous vehicle controller with a command corresponding with the driver intent,
wherein the autonomous vehicle controller controls the vehicle in a manner corresponding with the command when the autonomous vehicle controller receives the command.

7. The system of claim 6, wherein the first sensor comprises a touch sensitive surface configured to detect a gesture.

8. The system of claim 7, wherein the touch sensitive surface is mounted on a rim of a steering wheel of the vehicle.

9. The system of claim 7, wherein the gesture comprises movement of a touching member along the touch sensitive surface in a direction corresponding with a desired direction of lateral movement of the vehicle within a traffic lane.

10. The system of claim 7 wherein the gesture comprises movement of a touching member along the touch sensitive surface in a direction corresponding with a desired acceleration of the vehicle.

11. The system of claim 7, wherein the command further corresponds with a magnitude of the gesture.

12. The system of claim 7, wherein the processor is further configured to determine whether the gesture was intentionally made by the driver.

13. The system of claim 7, further comprising a memory unit communicatively coupled with the processor, the memory unit configured to store a data file containing information corresponding to the driver input.

14. The system of claim 13, wherein the processor is further configured to determine the driver intent based, at least in part, on the information stored in the data file.

15. The system of claim 14, wherein the memory unit is further configured to contain a plurality of data files for a respective plurality of drivers and wherein the processor is further configured to process and store data files and to determine the driver intent for each driver of the plurality of drivers based, at least in part, on the information stored in the plurality of data files.

16. The system of claim 14, further comprising a second sensor communicatively coupled with the processor, the second sensor configured to detect an environmental condition proximate the vehicle and to generate a second signal corresponding with the environmental condition, wherein the processor is further configured to obtain the second signal from the second sensor and to determine the driver intent based, at least in part, on the second signal.

17. The system of claim 16, wherein the second sensor comprises a proximity sensor.

18. A method for responding to a vehicle control instruction input by a driver into an autonomous vehicle controller while the autonomous vehicle controller is operating a vehicle in either an autonomous mode or a semi-autonomous mode, the method comprising the steps of:
detecting a driver input with a sensor;
generating, with the sensor, a signal corresponding with the driver input;
determining, with a processor, a driver intent based, at least in part, on the signal;
generating, with the processor, a command that corresponds with the driver intent;
providing the command to the autonomous vehicle controller; and
controlling the vehicle with the autonomous vehicle controller in a manner that corresponds with the command.

19. The method of claim 18, wherein the step for determining the driver intent includes determining whether the driver input was intentionally provided.

20. The method of claim 18, wherein the step for generating the signal comprises generating the signal such that the signal corresponds with a magnitude of the driver input.
